(19) United States
(12) Patent Application Publication
(10) Pub. No.: US 2018/0322596 A1
(43) Pub. Date: Nov. 8, 2018

(54) NON-TRANSITORY COMPUTER READABLE RECORDING MEDIUM, ITINERARY PLAN SUPPORT METHOD, AND ITINERARY PLAN SUPPORT DEVICE

(71) Applicant: FUJITSU LIMITED, Kawasaki-shi (JP)

(72) Inventors: Akihiro MIYAMOTO, Minato (JP); Fumito Ito, Kita (JP)

(73) Assignee: FUJITSU LIMITED, Kawasaki-shi (JP)

(21) Appl. No.: 16/026,910

(22) Filed: Jul. 3, 2018

Related U.S. Application Data
(63) Continuation of application No. PCT/JP2016/050173, filed on Jan. 5, 2016.

(51) Int. Cl. G06Q 50/14; G06Q 10/02; G06T 11/60

(52) U.S. Cl. CPC G06Q 50/14; G06T 11/60; G06Q 10/025

(57) ABSTRACT

A server receives registration of an itinerary plan including one or a plurality of spot information items. The server sets a reference status of the itinerary plan such that one or a plurality of registered members refer to the itinerary plan. The server detects that edit processing corresponding to any one of the one or plurality of members is executed with respect to the itinerary plan, in a state where a program of displaying messages exchanged with or among the one or plurality of registered members in a chronological order, is not executed. Thus, the server displays messages of notifying occurrence of edit processing or contents of the edit processing in a chronological order, in addition to the messages exchanged with or among the one or plurality of members, at the time of displaying the messages in a chronological order by executing the program.

### CROSS-REFERENCE TO RELATED APPLICATION(S)

This application is a continuation of International Application No. PCT/JP2016/050173, filed on Jan. 5, 2016, the entire contents of which are incorporated herein by reference.

### FIELD

The embodiments discussed herein are related to an itinerary plan support program and the like.

### BACKGROUND

Recently, there have been various conventional technologies of supporting preparation of an itinerary plan. For example, there is a conventional technology in which a spot popular for general users is selected from a plurality of spots relevant to entertainment, sports, culture, and the like in a predetermined area of a travel destination, and a plurality of types of itinerary plans of travelling around the selected spot are generated and are provided to a user.

Here, for example, in the conventional technology described above, it is difficult to prepare an itinerary plan for some users who are interested in a specific field but are not interested in sports or entertainment. In this respect, there is a conventional technology in which a user selects a spot from spots belonging to a specific field, and an itinerary plan including the selected spot is prepared.
Patent Literature 1: Japanese Laid-open Patent Publication No. 2005-107786
Patent Literature 2: Japanese Laid-open Patent Publication No. 2014-071479

However, in the conventional technology described above, it is not possible to efficiently notify updated information of the itinerary plan to the user.

### SUMMARY

According to an aspect of an embodiment, an itinerary plan support method includes: first allowing a display unit to display itinerary information sequentially indicating a plurality of spots included in an itinerary in association with marks different for each spot, and to display the same type of mark as the mark of each of the spots in the itinerary information, in a position on a map corresponding to each position of the plurality of spots, using a processor; and second allowing the display unit to display a mark by newly associating the mark with a third spot without changing a mark associated with a first spot and a second spot, in both the itinerary information and map information, at the time of newly adding the third spot between the first spot and the second spot included in the itinerary, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system according to a first embodiment;

FIG. 2 is a screen example of an itinerary plan which is displayed on a user terminal according to the first embodiment;

FIG. 3 is a diagram illustrating an example of a chat screen;

FIG. 4 is a functional block diagram illustrating a configuration of a server according to the first embodiment;

FIG. 5 is a diagram illustrating an example of a data structure of a group table;

FIG. 6 is a diagram illustrating an example of a data structure of a spot table;

FIG. 7 is a diagram illustrating an example of a data structure of an itinerary plan table;

FIG. 8 is a flowchart illustrating an example of processing in which the server of the first embodiment notifies a change of edit processing;

FIG. 9 is a flowchart illustrating an example of processing in which the server of the embodiment specifies a chat member;

FIG. 10 is a diagram illustrating an example of a system according to a second embodiment;

FIG. 11 is a screen example of an itinerary plan which is displayed on a user terminal according to the second embodiment;

FIG. 12 is a functional block diagram illustrating a configuration of a server according to the second embodiment;

FIG. 13 is a diagram illustrating an example of a data structure of a spot table according to the second embodiment;

FIG. 14 is a flowchart illustrating an example of a processing procedure of the server according to the second embodiment; and

FIG. 15 is a diagram illustrating an example of a computer executing an itinerary plan support program.

### DESCRIPTION OF EMBODIMENTS

Preferred embodiments of the present invention will be explained with reference to accompanying drawings. Furthermore, the present invention is not limited by such embodiments.

### [a] First Embodiment

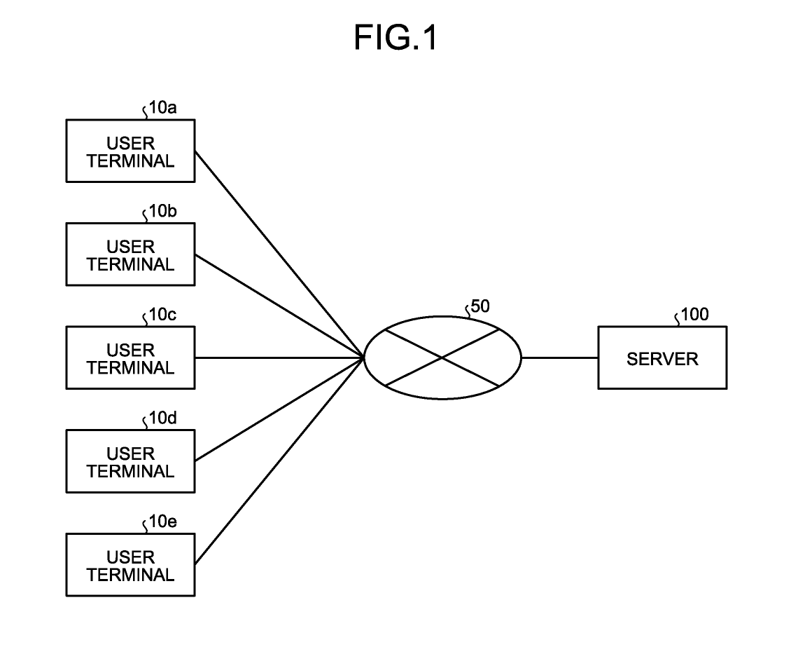

FIG. 1 is a diagram illustrating an example of a system according to a first embodiment. As illustrated in FIG. 1, the system includes user terminals 10a, 10b, 10c, 10d, and 10e, and a server 100. The server 100 is an example of an itinerary plan support device.

In FIG. 1, the user terminals 10a to 10e are illustrated, but the system may include other user terminals in addition to the user terminals 10a to 10e. In the following description, the user terminals 10a to 10e will be collectively and suitably referred to as a user terminal 10. The user terminal 10 and the server 100 are connected to each other through a network 50.

The user terminal 10 is a terminal device corresponding to a smart phone, a tablet terminal, a notebook personal computer (PC), or the like, which is used by a user. The user manipulates the user terminal 10, accesses the server 100, and chats with the other user with reference to information of an itinerary plan prepared along with the other user.

The server 100 is a device providing a chat service and a service relevant to preparation of the itinerary plan to the user terminal 10. For example, the server 100 arranges messages transmitted from the user terminal 10 in a chronological order, and notifies information of message strings which are chronologically arranged, to each of the user terminals 10, and thus, provides the chat service to the user terminal 10.

In a case where the information of the itinerary plan is received from each of the user terminals 10 and is registered, and access relevant to the information of the itinerary plan is received from the user terminal 10, the server 100 notifies the information of the itinerary plan, and displays the information of the itinerary plan on the user terminal 10.

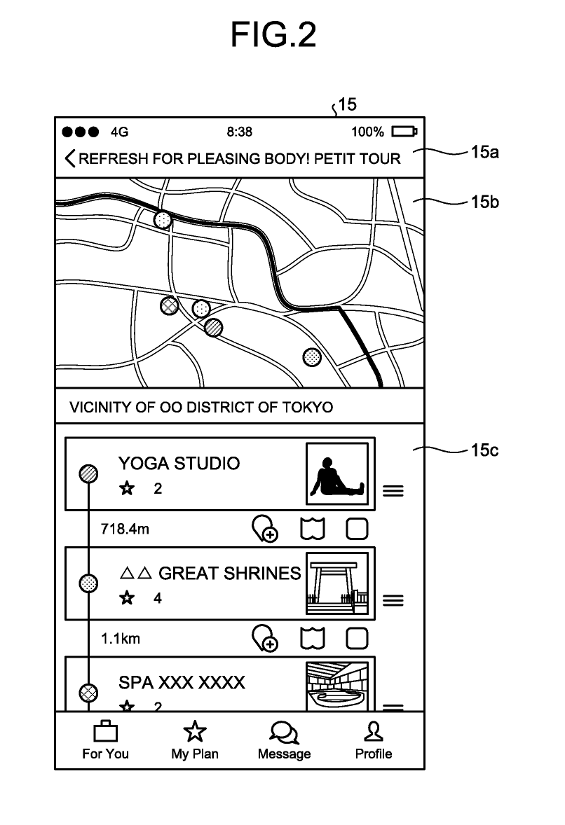

FIG. 2 is a screen example of the itinerary plan which is displayed on the user terminal according to the first embodiment. As illustrated in FIG. 2, a screen 15 of the itinerary plan includes a title region 15a, a map region 15b, and an itinerary region 15c. The title of the itinerary plan is displayed in the title region 15a. A position of a spot to be travelled in the itinerary plan is displayed in the map region 15b. Information of the spot to be travelled in the itinerary plan is chronologically displayed in the itinerary region 15c. The spot corresponds to a sightseeing spot or a store, leisure facility, or the like.

In addition, in a case where a certain user detects that edit processing with respect to the itinerary plan is executed while members joining in the itinerary plan do not chat with each other, the server 100 notifies the occurrence of the edit processing of the itinerary plan or the contents thereof when the next chat is performed.

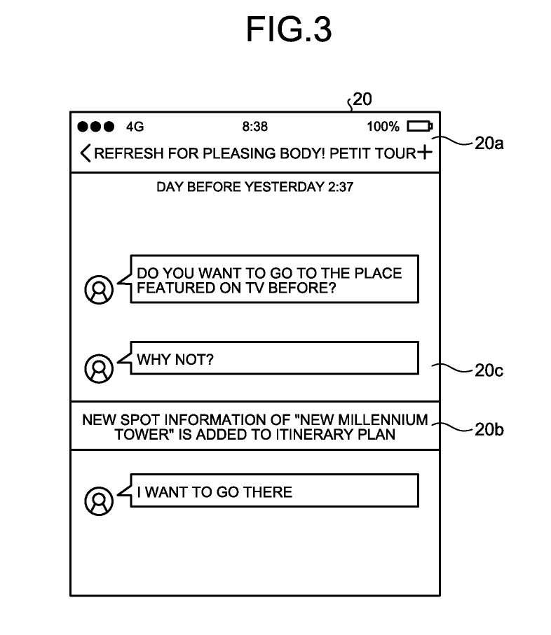

FIG. 3 is a diagram illustrating an example of a chat screen. As illustrated in FIG. 3, a chat screen 20 includes a title region 20a, a notification region 20b, and a chat region 20c. The title of the itinerary plan joined by each user who is chatting, is displayed in the title region 20a. The contents of the edit processing of the itinerary plan are displayed in the notification region 20b. For example, in a case where the user executes the edit processing with respect to the itinerary plan while the members joining in the itinerary plan do not chat with each other, the contents of the edit processing of the itinerary plan are displayed in the notification region 20b. Messages exchanged among the users are displayed in the chat region 20c in a chronological order. In addition, the notification region 20b may be included in the chat region 20c, and may be chronologically displayed.

For example, the edit processing corresponds to any one edit processing of deletion of a spot included in the itinerary plan, a sequence change of the spot included in the itinerary plan, and addition of a new spot to the itinerary plan.

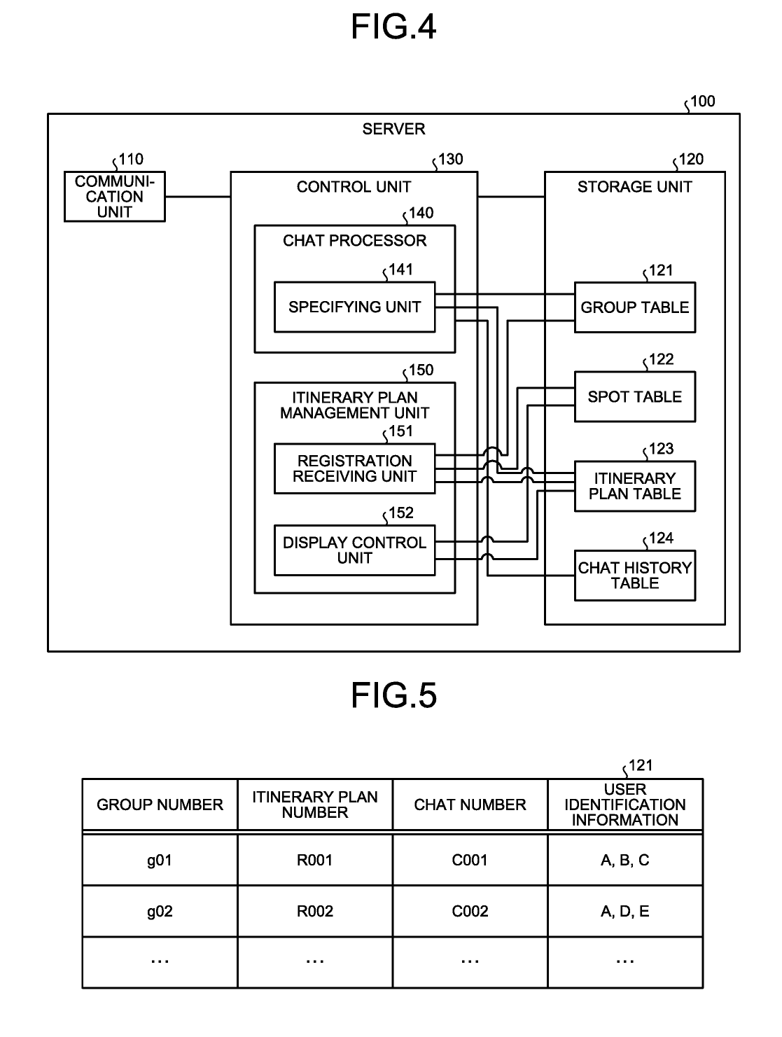

Next, the configuration of the server 100 according to the first embodiment will be described. FIG. 4 is a functional block diagram illustrating the configuration of the server according to the first embodiment. As illustrated in FIG. 4, the server 100 includes a communication unit 110, a storage unit 120, and a control unit 130.

The communication unit 110 is a processor executing data communication with respect to the user terminal 10 through the network 50. For example, the communication unit 110 corresponds to a communication device. The control unit 130 described below exchanges data with the user terminal 10 through the communication unit 110.

The storage unit 120 includes a group table 121, a spot table 122, an itinerary plan table 123, and a chat history table 124. The storage unit 120 corresponds to a storage device such as a semiconductor memory element such as a random access memory (RAM), a read only memory (ROM), and a flash memory, or a hard disk drive (HDD).

The group table 121 is a table of defining a relationship in the itinerary plan, the user joining in the itinerary plan, and the user included in a chat group. FIG. 5 is a diagram illustrating an example of a data structure of the group table. As illustrated in FIG. 5, in the group table 121, a group number, an itinerary plan number, a chat number, and user identification information are associated with each other.

The group number is a number of uniquely identifying a record of the group table 121. The itinerary plan number is a number of uniquely identifying the itinerary plan. The chat number is a number of uniquely identifying the chat group.

The user identification information is information of uniquely identifying the user. For example, the user terminal 10a is manipulated by a user A of user identification information of “A”. The user terminal 10b is manipulated by a user B of user identification information of “B”. The user terminal 10c is manipulated by a user C of user identification information of “C”. The user terminal 10d is manipulated by a user D of user identification information of “D”. The user terminal 10e is manipulated by a user E of user identification information of “E”.

For example, a record of a group number of “g01” of FIG. 5 will be described. A member joining in an itinerary plan number of “R001” is “the user A, the user B, and the user C”. In addition, a member belonging to a chat group of a chat number of “C001” is “the user A, the user B, and the user C”.

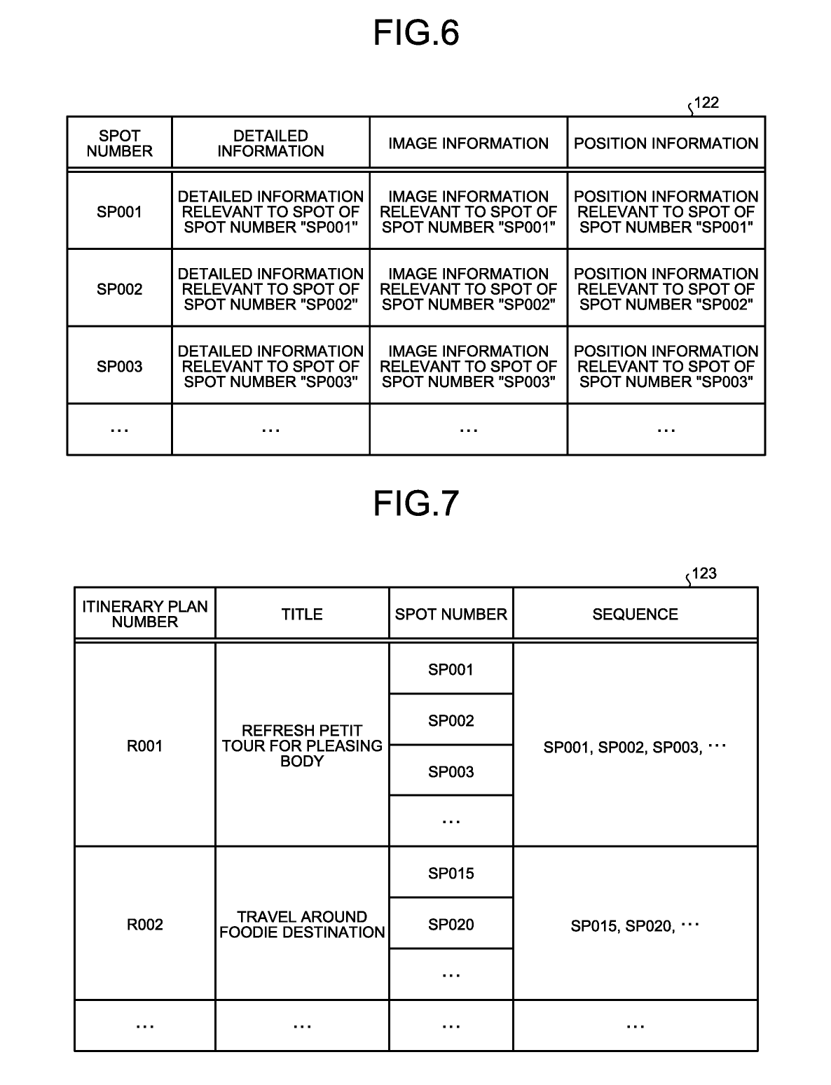

The spot table 122 is a table of retaining spot information. FIG. 6 is a diagram illustrating an example of the data structure of the spot table. As illustrated in FIG. 6, in the spot table 122, a spot number, detailed information, image information, and position information are associated with each other.

The spot number is a number of uniquely identifying the spot information. Furthermore, the spot corresponds to a sightseeing spot or a store, leisure facility, or the like. The detailed information is detailed information of the spot information. For example, the detailed information includes an address, a telephone number, a home page address, an opening hour, a closing day, access information, or the like of the spot. The image information is image information of the spot. The position information is information of position coordinates of the spot.

The itinerary plan table 123 is a table of retaining the information of the itinerary plan. FIG. 7 is a diagram illustrating an example of a data structure of the itinerary plan table. As illustrated in FIG. 7, in the itinerary plan table 123, an itinerary plan number, a title, a spot number, and a sequence are associated with each other. The itinerary plan number is a number of uniquely identifying the itinerary plan. The title is a title of an itinerary plan set by the user. The spot number is a number of uniquely identifying the spot information. The sequence indicates a sequence of the information of the spot to be travelled by the user.

For example, the itinerary plan of the itinerary plan number of “R001” includes spot information corresponding to spot numbers of “SP001, SP002, and SP003”. In addition, the sequence of travelling around the spot is indicated in the order of a spot of “SP001”, a spot of “SP002”, and a spot of “SP003”.

The chat history table 124 is a table of retaining the history of the message exchanged among the users.

Return to the description of FIG. 4. The control unit 130 includes a chat processor 140 and an itinerary plan management unit 150. The control unit 130 corresponds to an integrated device such as an application specific integrated circuit (ASIC) or a field programmable gate array (FPGA). In addition, the control unit 130, for example, corresponds to an electronic circuit such as a central processing unit (CPU) or a micro processing unit (MPU).

The chat processor 140 is a processor executing processing relevant to the chat service. The chat processor 140 executes processing of chronologically displaying messages exchanged among members registered in association with the itinerary plan. In addition, the chat processor 140 registers chat history information in the chat history table 124.

The chat processor 140 includes a specifying unit 141. The specifying unit 141 is a processor specifying a user who may refer to the itinerary plan with reference to the group table 121, in a case where the chat processor 140 is activated, and the chat service is started.

The processing of the specifying unit 141 will be described by using FIG. 5. For example, the user identification information items of “A, B, and C” are registered in the chat number of “C001”. In addition, the itinerary plan number of “R001” is set in the chat number of “C001”. In this case, the specifying unit 141 determines that the users A, B, and C may refer to the itinerary plan of the itinerary plan number of “R001”.

For example, in a case where the chat in the members is started by the processing of the chat processor 140, the specifying unit 141 notifies whether or not to refer to the itinerary plan corresponding to the itinerary plan number of “R001” to the user terminal 10 manipulated by the users A, B, and C. In a case where information to the effect of referring to the itinerary plan corresponding to the itinerary plan number of “R001” is received from the user terminal 10, the specifying unit 141 notifies the information of the itinerary plan corresponding to the itinerary plan number of “R001”.

In addition, in a case where the chat in the members is started by the processing of the chat processor 140, the specifying unit 141 accesses the itinerary plan table 123, and specifies information of a title corresponding to the itinerary plan number. The specifying unit 141 displays the specified information of the title in the title region 20a of the chat screen 20.

For example, an itinerary plan number corresponding to the chat number of “C001” is “R001”, and a title corresponding to the itinerary plan number of “R001” is “Refresh Petit Tour for Pleasing Body”. In this case, the specifying unit 141 displays the title of “Refresh Petit Tour for Pleasing Body” in the title region 20a of the chat screen 20 described in FIG. 3.

Return to the description of FIG. 4. The itinerary plan management unit 150 is a processor which receives the access from the user terminal 10, and executes various processings relevant to registration, display, update, or the like of the itinerary plan. The itinerary plan management unit 150 includes a registration receiving unit 151 and a display control unit 152.

The registration receiving unit 151 is a processor receiving the registration of the itinerary plan including one or a plurality of spot information items. For example, the registration receiving unit 151 receives the information of the itinerary plan from the user terminal 10, and updates the group table 121, the spot table 122, and the itinerary plan table 123, on the basis of the received information.

The information of the itinerary plan received from the user terminal 10 includes information in which the itinerary plan number, the chat number, and the user identification information are associated with each other. The registration receiving unit 151 associates the itinerary plan number, the chat number, and the user identification information with each other, and registers the associated information in the group table 121. Furthermore, the information of the group table 121 may be set in advance.

The information of the itinerary plan received from the user terminal 10 includes information in which the itinerary plan number, the spot number, the title, and the sequence are associated with each other. The registration receiving unit 151 associates the itinerary plan number, the spot number, the title, and the sequence with each other, and registers the associated information in the itinerary plan table 123.

The information of the itinerary plan received from the user terminal 10 includes information in which the spot number, the detailed information, the image information, and the position information are associated with each other. The registration receiving unit 151 associates the spot number, the detailed information, the image information, and the position information with each other, and registers the associated information in the spot table 122.

The registration receiving unit 151 repeatedly executes the processing described above whenever the information of the itinerary plan is received from the user terminal 10.

In a case where it is detected that the edit processing is executed with respect to the spot table 122 and the itinerary plan table 123 while the chat processor 140 is not activated, the display control unit 152 performs the subsequent processing when the chat processor 140 is activated. In a case where the chat processor 140 is activated, the display control unit 152 performs processing of displaying messages of notifying the contents of the edit processing in a chronological order, on the chat screen of the chat service provided by the chat processor 140.

For example, any one of the users A to C adds spot information of spot numbers of “SP022” and “SP023” to the itinerary plan of the itinerary plan number of “R001” while the chat processor 140 is not activated. In this case, in a case where the chat processor 140 is activated, and the users A to C start the chat, the display control unit 152 displays information to the effect that the spot information of the spot numbers of “SP022” and “SP023” is added, in the notification region 20b of the chat screen 20.

For example, the display control unit 152 records an end time of the chat and the subsequent start time for each chat number, and in a case where the edit processing is executed with respect to the itinerary plan from the end time of the chat to the subsequent start time, displays the contents of such edit processing in the notification region 20b. The edit processing is not limited to the addition of the spot information as described above, and includes the deletion of the spot information, the change of the sequence, and the like.

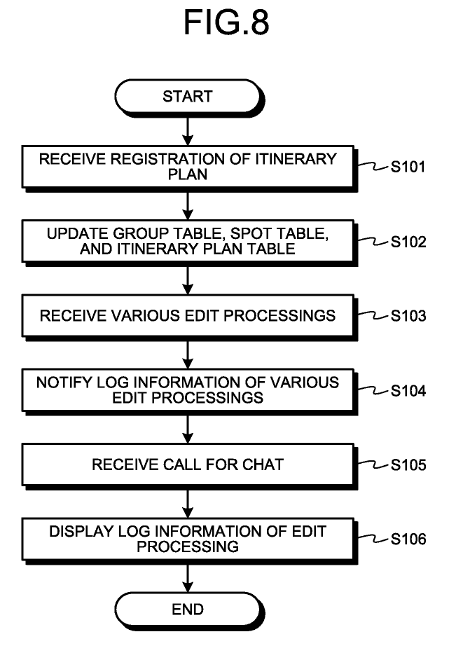

Next, an example of a processing procedure of the server 100 according to the first embodiment will be described. FIG. 8 is a flowchart illustrating an example of processing in which the server notifies a change in the edit processing. As illustrated in FIG. 8, the itinerary plan management unit 150 of the server 100 receives the registration of the itinerary plan from the user terminal 10 (Step S101). The itinerary plan management unit 150 updates the group table 121, the spot table 122, and the itinerary plan table 123 (Step S102).

The itinerary plan management unit 150 receives various edit processings with respect to the itinerary plan (Step S103). The itinerary plan management unit 150 notifies log information of various edit processings received until the chat processor 140 is activated, to the chat processor 140 (Step S104).

In a case where a call for a chat is received, the chat processor 140 is activated (Step S105), and the log information of the edit processing is displayed (Step S106).

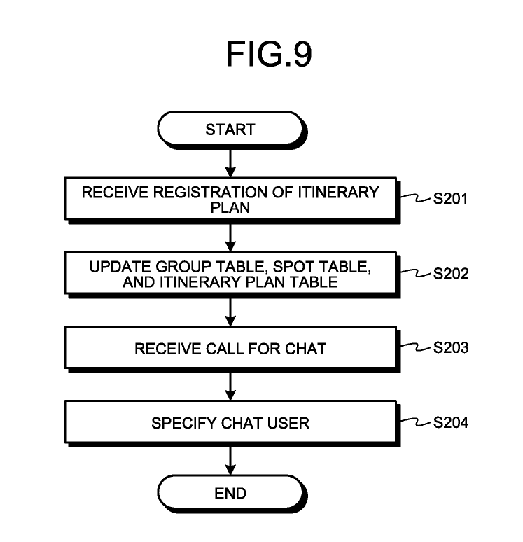

FIG. 9 is a flowchart illustrating an example of processing in which the server specifies the chat member. As illustrated in FIG. 9, the itinerary plan management unit 150 of the server 100 receives the registration of the itinerary plan from the user terminal 10 (Step S201). The itinerary plan management unit 150 updates the group table 121, the spot table 122, and the itinerary plan table 123 (Step S202).

In a case where the call for a chat is received, the chat processor 140 of the server 100 is activated (Step S203), a user who chats, is specified on the basis of the group table 121 (Step S204).

Next, effects of the server 100 according to the first embodiment will be described. In a case where the itinerary plan is edited before the chat in the users joining in the same itinerary plan is started, the server 100 according to the first embodiment displays the contents of the edited itinerary plan in the chat screen when the chat is started. For this reason, according to the server 100, the updated information of the itinerary plan can be efficiently notified to the user.

In addition, in a case where the users joining in the itinerary plan are registered, the server 100 performs control such that the users registered in the same itinerary plan to join in the chat. For this reason, the user can chat with the users joining in the same itinerary plan without reconstructing the chat group.

In addition, the server 100 performs processing of displaying the title of the itinerary plan joined by the user in chatting, on the chat screen. For this reason, even in a case where the user joins in a plurality of itinerary plans, it is possible to easily grasp which chat in the users joining in the itinerary plan is the current chat.

### [b] Second Embodiment

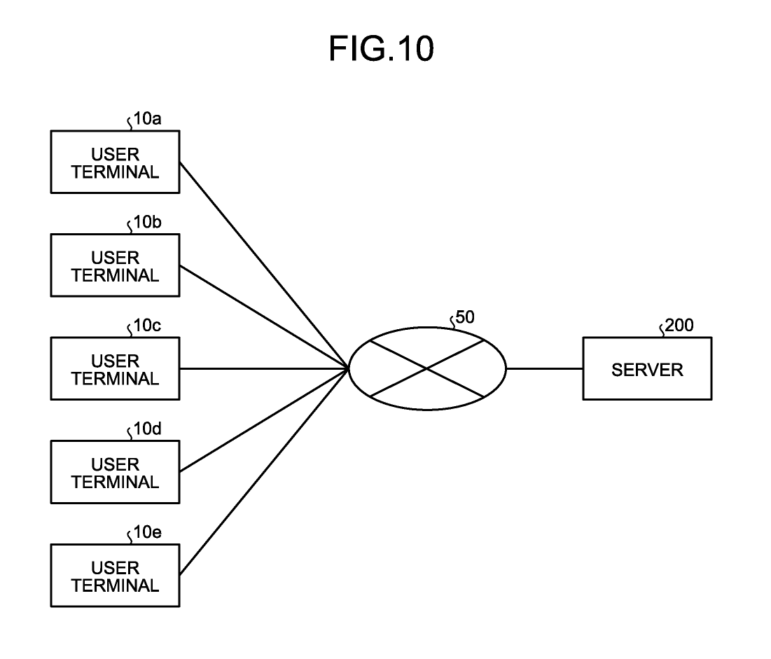

FIG. 10 is a diagram illustrating an example of a system according to the second embodiment. As illustrated in FIG. 10, the system includes user terminals 10a, 10b, 10c, 10d, and 10e, and a server 200. The server 200 is an example of an itinerary plan support device. The description of the user terminals 10a to 10e is identical to the description of the user terminals 10a to 10e illustrated in FIG. 1. The user terminals 10a to 10e will be collectively and suitably referred to as the user terminal 10. The user terminal 10 and the server 200 are connected to each other through the network 50.

The server 200 is a device providing a chat service and a service relevant to preparation of the itinerary plan to the user terminal 10. For example, the server 200 arranges messages transmitted from the user terminal 10 in a chronological order, and notifies information of message strings which are chronologically arranged, to each of the user terminals 10, and thus, provides the chat service to the user terminal 10.

In a case where the information of the itinerary plan is received from each of the user terminals 10, and is registered, and access relevant to the information of the itinerary plan is received from the user terminal 10, the server 200 notifies the information of the itinerary plan, and displays the information of the itinerary plan on the user terminal 10.

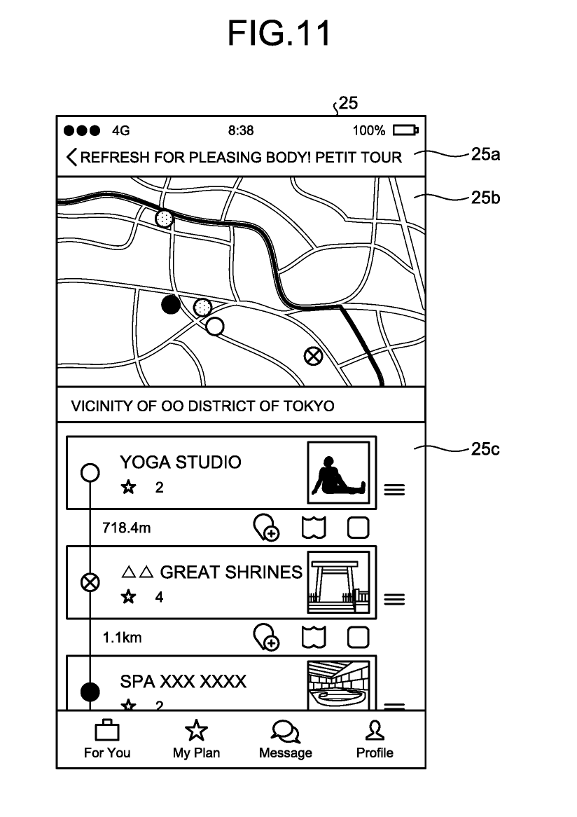

FIG. 11 is a screen example of the itinerary plan which is displayed on the user terminal according to the second embodiment. As illustrated in FIG. 11, a screen 25 of the itinerary plan includes a title region 25a, a map region 25b, and an itinerary region 25c. The title of the itinerary plan is displayed in the title region 25a. A position of a spot to be travelled in the itinerary plan is displayed in the map region 25b. Information of the spot to be travelled in the itinerary plan is chronologically displayed in the itinerary region 25c. The spot corresponds to a sightseeing spot or a store, leisure facility, or the like.

Here, the server 200 assigns a mark unique for a spot to each spot information item included in the itinerary plan. The server 200 displays the position of the spot included in the map region 25b by a unique mark assigned to the spot. In addition, the server 200 displays the mark unique for a spot in association with each of the spot information items of the itinerary region 25c.

In a case where new spot information is added to the itinerary plan, the server 200 executes processing of assigning a mark other than the mark assigned to the spot information registered in advance, as a mark of the new spot information. Furthermore, in the second embodiment, an example of assigning the unique mark to each of the spot information items is described, but a color may be assigned instead of the mark, or a combination of the mark and the color may be used, as an example.

In addition, in a case where the spot information is displayed in the itinerary region 25c, the server 200 displays a distance between the respective spots and an estimated time for movement. Furthermore, in a case where new third spot information is added between first spot information and second spot information in the itinerary plan, the server 200 displays a distance between a first spot and a third spot, or an estimated time. In addition, the server 200 displays a distance between the third spot and a second spot, or an estimated time.

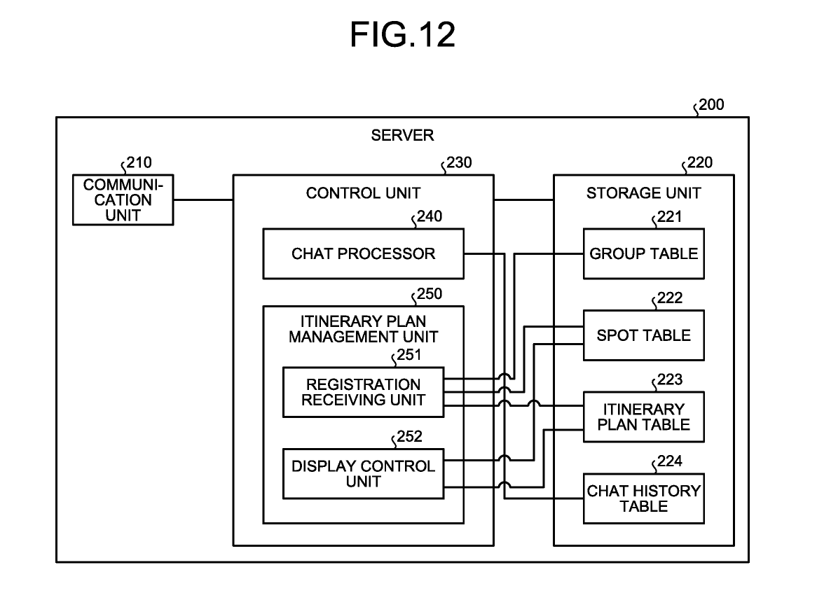

Next, the configuration of the server 200 according to the second embodiment will be described. FIG. 12 is a functional block diagram illustrating the configuration of the server according to the second embodiment. As illustrated in FIG. 12, the server 200 includes a communication unit 210, a storage unit 220, and a control unit 230.

communication unit 210 is a processor executing data communication with respect to the user terminal 10 through the network 50. For example, the communication unit 210 corresponds to a communication device. The control unit 230 described below exchanges data with the user terminal 10 through the communication unit 210.

The storage unit 220 includes a group table 221, a spot table 222, an itinerary plan table 223, and a chat history table 224. The storage unit 220 corresponds to storage device such as a semiconductor memory element such as a RAM, a ROM, and a flash memory, or an HDD.

Among them, the description of the group table 221, the itinerary plan table 223, and the chat history table 224 is identical to the description of the group table 121, the itinerary plan table 123, and the chat history table 124 illustrated in FIG. 4.

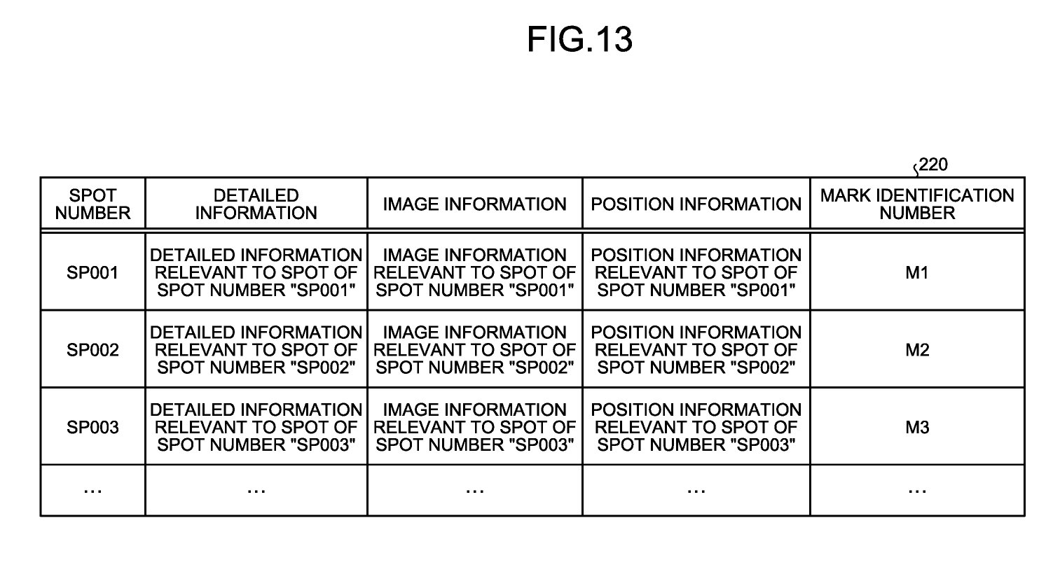

The spot table 222 is a table of retaining the spot information. FIG. 13 is a diagram illustrating an example of a data structure of the spot table according to the second embodiment. As illustrated in FIG. 13, in the spot table 222, a spot number, detailed information, image information, position information, and a mark identification number are associated with each other. The description of the spot number, the detailed information, the image information, and the position information is identical to the description of the spot number, the detailed information, the image information, and the position information described in FIG. 6.

The mark identification number is information of uniquely identifying the mark assigned to the spot information. For example, in a record of the first row of in FIG. 13, it is illustrated that a mark of a mark identification number of “M1” is assigned to spot information of a spot number of “SP001”. A unique mark identification number is assigned to each of the spot numbers.

Return to the description of FIG. 12. The control unit 230 includes a chat processor 240 and an itinerary plan management unit 250. The control unit 230 corresponds to an integrated device such as an ASIC or an FPGA. In addition, the control unit 230, for example, corresponds to an electronic circuit such as a CPU or an MPU.

The chat processor 240 is a processor executing processing relevant to the chat service. The chat processor 240 executes processing of chronologically displaying messages exchanged among members registered in associated with the itinerary plan. In addition, the chat processor 240 registers chat history information in the chat history table 224.

The itinerary plan management unit 250 is a processor which receives the access from the user terminal 10, and executes various processings relevant to registration, display, update, or the like of the itinerary plan. The itinerary plan management unit 250 includes a registration receiving unit 251 and a display control unit 252. The display control unit 252 corresponds to a first display control unit and a second display control unit.

The registration receiving unit 251 is a processor receiving the registration of the itinerary plan including one or a plurality of spot information items. For example, the registration receiving unit 251 receives the information of the itinerary plan from the user terminal 10, and updates the group table 221, the spot table 222, and the itinerary plan table 223, on the basis of the received information.

The information of the itinerary plan received from the user terminal 10 includes information in which the itinerary plan number, the chat number, and the user identification information are associated with each other. The registration receiving unit 251 associates the itinerary plan number, the chat number, and the user identification information with each other, and registers the associated information in the group table 221. Furthermore, the information of the group table 221 may be set in advance.

The information of the itinerary plan received from the user terminal 10 includes information in which the itinerary plan number, the spot number, the title, and the sequence are associated with each other. The registration receiving unit 251 associates the itinerary plan number, the spot number, the title, and the sequence with each other, and registers the associated information in the itinerary plan table 223.

The information of the itinerary plan received from the user terminal 10 includes information in which the spot number, the detailed information, the image information, and the position information are associated with each other. The registration receiving unit 251 associates the spot number, the detailed information, the image information, and the position information with each other, and registers the associated information in the spot table 222.

Further, the registration receiving unit 251 randomly selects the mark identification number assigned to the spot number from a plurality of mark identification numbers. The assignment of the mark identification number to the spot number corresponds to the assignment of the mark to the spot information corresponding to the spot number.

In a case where the selected mark identification number is not assigned to the other spot number, the registration receiving unit 251 registers the selected mark identification number in the spot table 222, in association with the spot number. On the other hand, in a case where the selected mark identification number is assigned to the other spot number, the registration receiving unit 251 repeatedly executes the processing described above until the unique mark identification number is assigned to the spot number.

In a case where information of new itinerary plan is received from the user terminal 10, the registration receiving unit 251 assigns the unique mark identification number to a new spot number without changing the mark identification number assigned in advance to each of the spot numbers.

The registration receiving unit 151 repeatedly executes the processing described above whenever the information of the itinerary plan is received from the user terminal 10.

The display control unit 252 is a processor which generates the screen information of the itinerary plan, described in FIG. 11, and notifies the generated screen information to the user terminal 10. For example, the display control unit 252 specifies spot information and a spot sequence included in the itinerary plan, with reference to the itinerary plan table 223. In addition, the display control unit 252 specifies the unique mark assigned to the spot information, from the mark identification number assigned to the spot information, with reference to the spot table 222. Even though it is not illustrated, a table in which the mark identification number and the mark are associated with each other, is stored in the storage unit 220, and the display control unit 252 specifies the mark, with reference to the table.

The display control unit 252 arranges the spot information items with respect to the itinerary plan, according to a sequence of the specified spot information, and thus, generates information of the itinerary region 25c. A mark unique for spot information is associated with each of the spot information items.

For example, a case of generating the itinerary region 25c corresponding to the itinerary plan number of “R001” will be described. The display control unit 252 allocates the spot information in the itinerary region 25c, in the order of spot information of spot numbers of “SP001”, “SP002”, and “SP003” corresponding to the itinerary plan number of “R001”. In addition, the display control unit 252 specifies the mark identification number corresponding to each of the spot numbers, with reference to the spot table 222, and allocates the specified mark identification number in the itinerary region 25c, in association with the spot information.

In addition, the display control unit 252 specifies a position on a map of the spot information, on the basis of the position information of the spot table 222, and allocates the mark unique for spot information in the specified position, and thus, generates the information of the map region 25b.

For example, the display control unit 252 acquires position information corresponding to the spot numbers of “SP001”, “SP002”, and “SP003”, from the spot table 222, and allocates the mark in a position corresponding to the spot number of the map region 25b.

In addition, the display control unit 252 calculates a distance between the respective spots, on the basis of the position information of each of the spot information items, and stores the calculated distance in the screen information of the itinerary plan. In addition, the display control unit 252 calculates an estimated time for movement from a spot to the other spot, on the basis of a walking speed of a general user or a movement time of a train or the like, and stores the calculated time in the screen information of the itinerary plan. For example, the distance between the respective spots, and the estimated time are displayed in association with each of the spot information items of the itinerary region 25c. Furthermore, the estimated time for movement may be calculated on the basis of a transportation selected by the user. For example, in the transportation including a vehicle, a train, an airplane, a walk, or the like, the selection of the transportation between the respective spots may be received, and the estimated time for movement may be calculated on the basis of the selected transportation.

The display control unit 252 repeatedly executes processing described above whenever the new spot information is added to the information of the itinerary plan, and the spot table 222 and the itinerary plan table 223 are updated by the registration receiving unit 251.

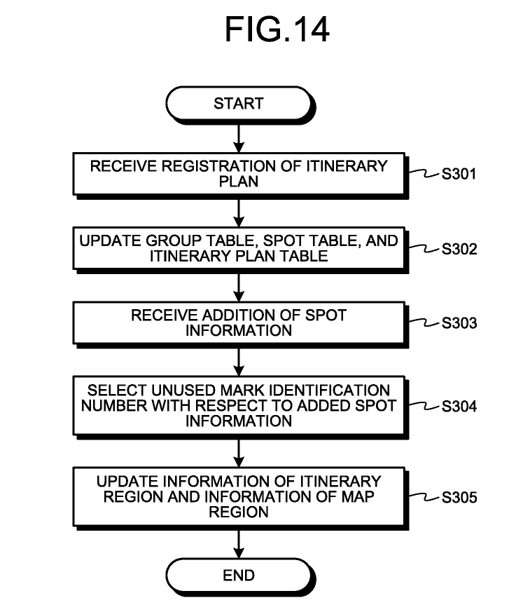

Next, an example of a processing procedure of the server 200 according to the second embodiment will be described. FIG. 14 is a flowchart illustrating an example of the processing procedure of the server according to server of the second embodiment. As illustrated in FIG. 14, the itinerary plan management unit 250 of the server 200 receives the registration of the itinerary plan (Step S301). The itinerary plan management unit 250 updates the group table 221, the spot table 222, and the itinerary plan table 223 (Step S302).

The itinerary plan management unit 250 receives the addition of the spot information (Step S303). The itinerary plan management unit 250 selects unused mark identification information with respect to the added spot information (Step S304). The itinerary plan management unit 250 updates the information of the itinerary region and the information of the map region (Step S305).

Next, effects of the server 200 according to the second embodiment will be described. The server 200 assigns the unique mark to the spot information included in the itinerary plan, and displays the assigned mark and the spot information in the itinerary region and the map region in association with each other. In addition, even in a case where the new spot information is added to the itinerary plan, the unique mark is assigned to the new spot information without changing the previous marks assigned to the spot information. The unique mark assigned to the spot information is not changed, and thus, the user easily stores a relationship between the spot information and a spot position on the map.

In addition, the server 200 displays the distance between the respective spots, and the estimated time for movement together, and thus, the user can easily grasp how much time to enjoy the sightseeing in each of the spots included in the itinerary plan.

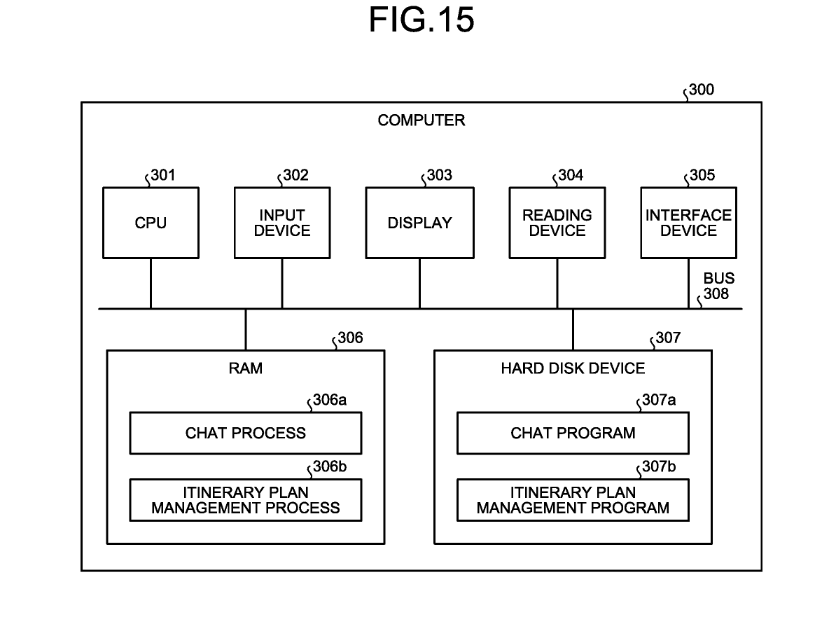

Next, an example of a computer executing an itinerary plan support program of realizing the same function as that of the servers 100 and 200 described in the embodiments described above, will be described. FIG. 15 is a diagram illustrating an example the computer executing the itinerary plan support program.

As illustrated in FIG. 15, a computer 300 includes a CPU 301 executing various arithmetic processings, an input device 302 receiving input of data from the user, and a display 303. In addition, the computer 300 includes a reading device 304 reading a program or the like from a storage medium, and an interface device 305 performing data delivery with respect to the other computer through a network. In addition, the computer 300 includes a RAM 306 temporarily storing various information items, and a hard disk device 307. Then, each of the devices 301 to 307 is connected to a bus 308.

The hard disk device 307 includes a chat program 307a and an itinerary plan management program 307b. The CPU 301 reads out the chat program 307a and the itinerary plan management program 307b, and decompresses the program in the RAM 306.

The chat program 307a functions as a chat process 306a. The itinerary plan management program 307b functions as an itinerary plan management process 306b.

The processing of the chat process 306a corresponds to the processing of the chat processors 140 and 240. The processing of the itinerary plan management process 306b corresponds to the processing of the itinerary plan management units 150 and 250.

Furthermore, it is also preferable that the chat program 307a and the itinerary plan management program 307b are not stored in the hard disk device 307 from the beginning. For example, each of the programs may be stored in a “transportable physical medium” such as a flexible disk (FD), a CD-ROM, a DVD disk, a magnetooptical disk, and an IC card, inserted into the computer 300. Then, the computer 300 may read out and execute each of the programs 207a and 207b.

It is possible to efficiently notify updated information of an itinerary plan to a user.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An itinerary plan support method comprising:
first allowing a display unit to display itinerary information sequentially indicating a plurality of spots included in an itinerary in association with marks different for each spot, and to display the same type of mark as the mark of each of the spots in the itinerary information, in a position on a map corresponding to each position of the plurality of spots, using a processor; and
second allowing the display unit to display a mark by newly associating the mark with a third spot without changing a mark associated with a first spot and a second spot, in both the itinerary information and map information, at the time of newly adding the third spot between the first spot and the second spot included in the itinerary, using the processor.

2. The itinerary plan support method according to claim 1, wherein the second allowing allows the display unit to display a distance between the first spot and the new spot, or an estimated time, and a distance between the new spot and the second spot, or an estimated time when a new spot is added.

3. An itinerary plan support device, comprising:
a processor that executes a process comprising:
receiving registration of an itinerary plan including one or a plurality of spot information items;
setting a reference status of the itinerary plan such that one or a plurality of registered members refer to the itinerary plan, according to registration of the one or a plurality of members; and
displaying messages of notifying occurrence of edit processing or contents of the edit processing in a chronological order, in addition to messages exchanged among the one or plurality of members, at the time of displaying the messages in a chronological order by executing a program of displaying the messages exchanged among the one or plurality of registered members in a chronological order, in a case of detecting that edit processing corresponding to any one of the one or plurality of members is executed with respect to the itinerary plan in a state in which the program of displaying the messages is not executed.

4. The itinerary plan support device according to claim 3, wherein the edit processing is any one edit processing of deletion of a spot included in the itinerary plan, a sequence change of the spot included in the itinerary plan, and addition of a new spot to the itinerary plan.

5. An itinerary plan support device, comprising:
a processor that executes a process comprising:
receiving registration of an itinerary plan including one or a plurality of spots;
changing a reference status of the itinerary plan such that one or a plurality of members refer to the itinerary plan, according to registration of the one or plurality of members; and
specifying a target member exchanging a message by a tool of exchanging a message, by using registration information of the one or plurality of members, in a case in which the tool is activated on a display screen of the itinerary plan.

6. The itinerary plan support device according to claim 5,
wherein the registration of the itinerary plan includes registration of titles of a plurality of the itinerary plans, and
the title of the itinerary plan is used for displaying a title on a screen corresponding to the tool.

7. An itinerary plan support device, comprising:
a processor that executes a process comprising:
first allowing a display unit to display itinerary information sequentially indicating a plurality of spots included in an itinerary in association with marks different for each spot, and to display the same type of mark as the mark of each of the spots in the itinerary information, in a position on a map corresponding to each position of the plurality of spots; and
second allowing the display unit to display a mark by newly associating the mark with a third spot without changing a mark associated with a first spot and a second spot, in both the itinerary information and map information, at the time of newly adding the third spot between the first spot and the second spot included in the itinerary.

8. The itinerary plan support device according to claim 7, wherein the second allowing allows the display unit to display a distance between the first spot and the new spot, or an estimated time, and a distance between the new spot and the second spot, or an estimated time when a new spot is added.
